(19) United States
(12) Patent Application Publication
(10) Pub. No.: US 2008/0064488 A1
(43) Pub. Date: Mar. 13, 2008

(54) GAME WAGERING SYSTEM AND METHOD

(75) Inventor: Je Seon Oh, Millersville, MD (US)

Correspondence Address: DLA PIPER US LLP;ATTN: PATENT GROUP, 500 8th Street, NW, WASHINGTON, DC, 20004-2131, US

(73) Assignee: GLOBAL INTERACTIVE GAMES LLC, Arlington, VA (US)

(21) Appl. No.: 11/753,333

(22) Filed: May 24, 2007

Related U.S. Application Data
(60) Provisional application No. 60/803,190, filed on May 25, 2006.
(60) Provisional application No. 60/821,768, filed on Aug. 8, 2006.

(51) Int. Cl. A63F 13/00

(52) U.S. Cl. 463/25; 463/42

(57) ABSTRACT

A system and method are provided for facilitating wagering by a user on a game of skill. The system can include a gaming network server, and a user gaming device. The user gaming device may include a display device, an input device, and a communications device, the communications device being operable to communicate with the gaming network server, and the user gaming device being configured to allow the user to participate in a game of skill against at least one opponent. The system also includes a wagering server, wherein the wagering server is configured to have the capability to accept a wager from the user gaming device or from the gaming network server.

### CROSS REFERENCE TO RELATED APPLICATIONS

This application is based on, and claims priority to, U.S. Provisional Application Ser. No. 60/803,190, filed May 25, 2006, and U.S. Provisional Application Ser. No. 60/821,768, filed Aug. 8, 2006, the entire contents of which are hereby incorporated by reference.

### BACKGROUND

1. Field

This invention relates to a game wagering system and method that is capable of being integrated into a gaming device.

2. Discussion of the Background

The internet has become a fertile ground for video game enthusiasts especially when such video game is based on the skill of a player rather than on chance. A game of skill is a game where the outcome is determined by mental or physical skill, rather than by chance. A Tetris Tournament, for example, requires a player to use hand-eye coordination and spatial relations skills necessary to successfully and accurately place the various shapes into proper spaces in a timely fashion, which takes skill. As another example, a game like chess contains no chance and requires the skill of a player to determine the outcome. On the other hand, a game of chance is generally considered to be a game in which chance is the sole or predominant determination of the outcome. The distinction between games of skill and games of chance is an important one, because games of chance are considered gambling (which may be illegal) whereas games of skill are not. The federal law and most states follow the Standard Lottery Rule, which is a general rule governing sweepstakes and skill based games. The Standard Lottery Rule states that gambling involves any activity in which each of the following elements is present: (1) the award of a prize, (2) determined on the basis of chance, and (3) where consideration is paid. If, however, any of these three elements is missing, then the activity is not considered gambling. The prevailing rule in the United States is the element of chance is met if the activity requires some skill, but chance is predominate.

### BRIEF DESCRIPTION OF THE DRAWINGS

Reference is made to the attached drawings, wherein elements having the same reference designations represent like elements throughout and wherein:

FIG. 1A illustrates a block diagram of a game wagering system that permits a user 102 to select a network which supports a wagering platform;

FIG. 1B illustrates an exemplary interface that may be presented to a user to enable the user to sign in to an online wagering network;

FIG. 1C illustrates an exemplary interface that may be presented to a user to enable such a user to wager or play for money during a match;

FIG. 2 illustrates in flow-chart form the process by which a user can select a game mode;

FIG. 3A illustrates an embodiment of a system for wagering in a multi-player/single player live game;

FIG. 3B illustrates an exemplary interface that can be presented to an opponent to accept or reject (cancel) an offer to play a match against another player;

FIG. 3C illustrates an exemplary interface which may be presented to a user/player after he/she accepts an offer to play a match against an opponent;

FIG. 3D illustrates an exemplary interface that may be presented to a prospective user so that such a user may choose a match to participate in; and

FIG. 3E illustrates an exemplary interface that can be presented to a player so that the player can provide either positive or negative feedback about his/her opponent.

### DETAILED DESCRIPTION

Most video game enthusiasts tend to focus on one to three games at any one time. Thus, a wagering system that is integrated seamlessly into a preexisting game title is desirable. A single sign-on site or application specific to picking games to wager on may be palatable for most gamers when the wagering is a natural extension of a particular game's environment, and easily accessible for such gamers. This is because the wagering aspect of the game does not become or replace the sole reason to play the game, which is the game itself. Therefore, it does not carry the risk of pushing ordinary gamers away. Instead, a wagering system that is fully integrated within the video game itself offers users/players a sandbox to become more comfortable with the notion of wagering as it is merely a simple extension of their gaming experience.

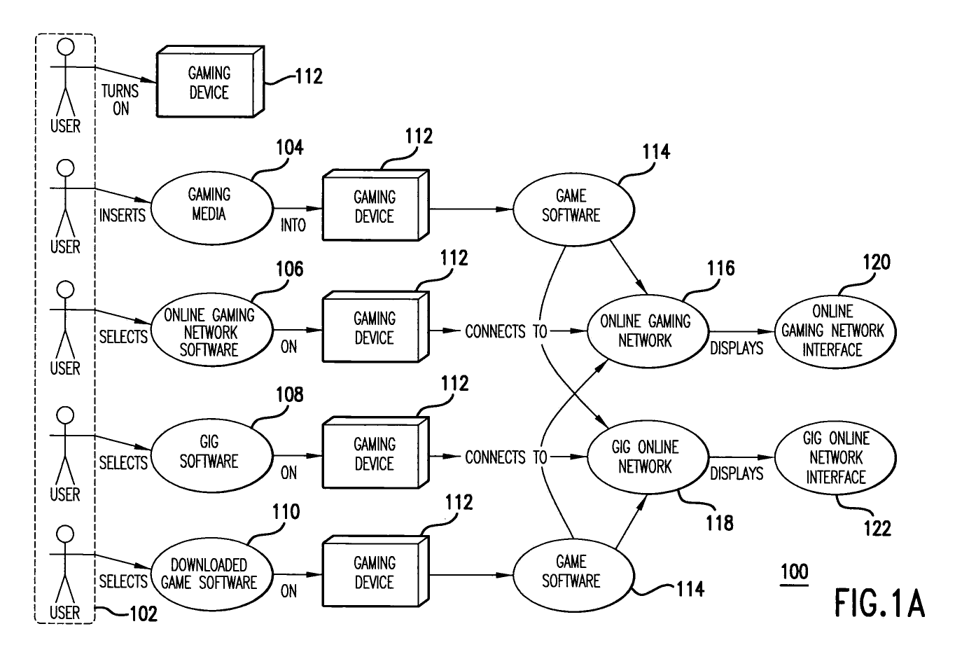

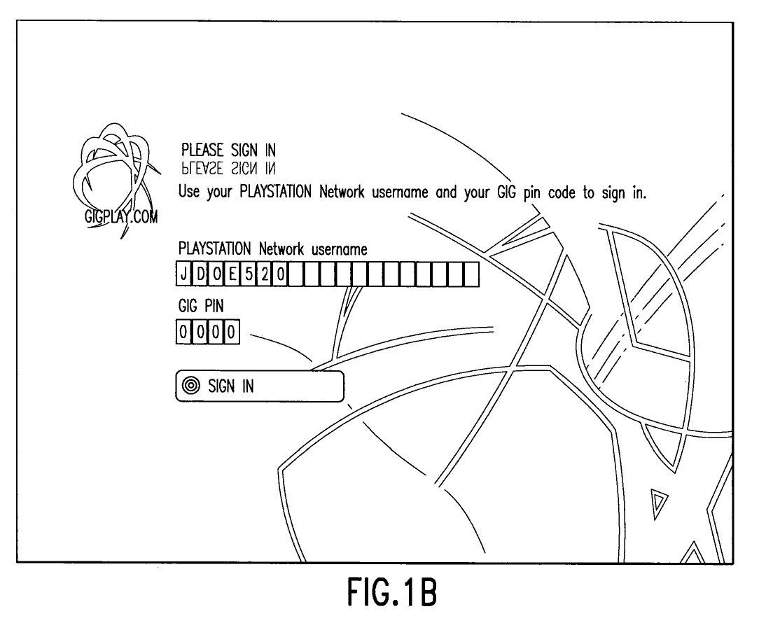

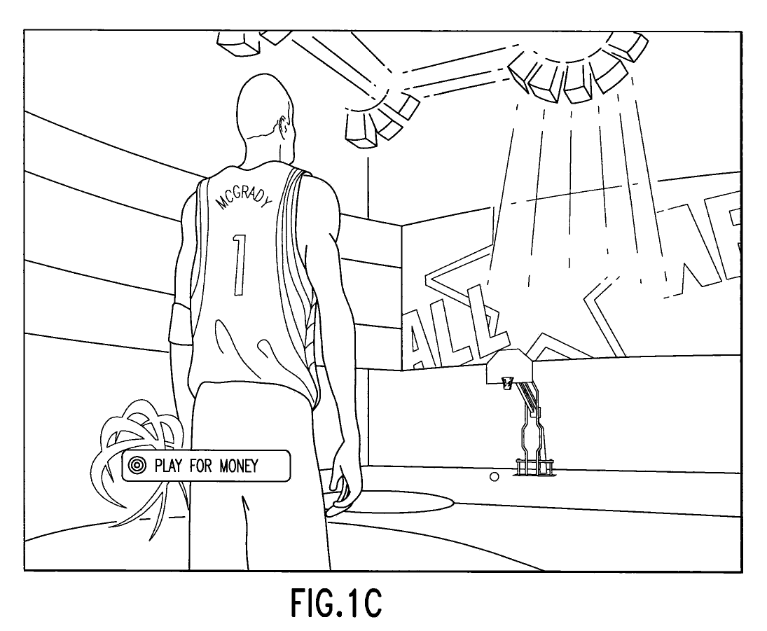

FIG. 1A illustrates a flow diagram of a game wagering system that permits a user 102 to select a network which supports a wagering platform after the user 102 activates a gaming device 112. The wagering platform is configured to be user friendly through integration of such platforms into each game. Therefore, transactions can take place directly through the console instead of requiring players to conduct transactions (e.g., registration, cash out) off-site or with a third party. That is, the wagering can be maintained as a feature within a game rather than as a mutation of the game. This may provide players with the confidence to wager because tournaments entered are the same as tournaments in which such players have a vested interest in winning. Therefore, the wagering system can become as incidental to the match as all other parameters of that match, such as number of players allowed, map chosen and the number of points or accomplishments needed to consider the match complete. Virtual tournaments within a game may be a logical extension of a game based tournament wagering system. Beyond simple evaluations of wins and losses to determine ways to distribute a pot to the competitors, individual aspects of a game match can be wagered. This records a player for excelling in an area in which the player has a particular strength and makes players more comfortable with wagering. It also increases the number of transactions per match so as to lower the “impulse buy” threshold for placing wagers. Multiple wager pools can exist simultaneously for a single match, with each pool covering disparate properties of the match.

The gaming device 112 is capable of controlling a game that includes wagering. Gaming device 112 can include video game console units, PCs, mobile phones, and/or wireless devices. The gaming device may operate over different types of networks such as the Internet, intranets, LANs (local area network), virtual LANs, WANs (wide area network), the PSTN (public switched telephone network), cellular networks, or public and/or private networks over which data may be transmitted. The gaming device 112 can be connected to an analog or digital television or other analog or digital display using a digital or analog cable. The gaming device 112 uses this connection to send information to the television or display, which is then presented to the user 102 visually. The gaming device 112 can also be connected to a set of speakers and/or headphones, freestanding or as part of a television, display, component audio system or other audio device. The gaming device 112 can use this connection to send audio information to the speakers, headphones or other audio device, which may then be presented to the user 102 aurally. Further, the gaming device 112 can be connected to a handheld input device using a cable or wireless connection over the infra-red (IR) or radio frequency (RF) electromagnetic (EM) spectrum. The user 102 can use the input device to send information to the gaming device to direct the behavior of the device or the software the device is running, including games. The gaming device 112 is capable of connecting to a wired or wireless headset, which allows the user 102 to send information to the gaming device 112 through the headset's built-in microphone. This information can then be interpreted by the gaming device 112. The interpreted information controls the operations of the gaming device 112. The headset can receive information from the gaming device 112, which then can be presented to the user 102 either aurally through an earphone or visually through a display connected to the headset.

The gaming device 112 can have a slot, tray or other input that can accept a disk cartridge or optical disc, such as a CD-ROM, DVD-ROM or other proprietary media. The disk cartridge or optical disc may contain software, which may be a game, application, system level application, device driver, an update for the gaming device's firmware, CD-ROM, DVD-ROM, HD-DVD or other media containing software, audio content, video content and/or image content.

Further, the gaming device 112 may be connected to an online network of server hosts or peer-to-peer nodes. As used herein, “online” refers to communication over a network (Internet, WAN, LAN, PSTN, or other networks, including wireless networks). The gaming device operating system or firmware provides a programmer interface to access an online network to connect to servers, peer-to-peer nodes or to other gaming devices that are also connected to the online network.

When turned on, the gaming device 112 presents the user 102 with a visual interface to access the online network in order to compete against other players. Each interface can be custom designed for each game to ensure the highest level of user-friendliness and to speed up all transactions between a player and the wagering system/game server by eliminating the need to end a game in order to conduct transactions. In an embodiment, the user 102 can insert into the gaming device 112, the disk cartridge or optical disc containing a game, games or gaming software, such that the software presents the user 102 with a visual interface to access an online network to compete against other players. FIG. 1B illustrates an exemplary interface that may be presented to a user to enable the user to sign in to an online wagering network. The user 102 can be prompted to provide his/her username, wagering pin-code and/or password to enable the user to sign in.

A user can access an online gaming network 116 and/or an online wagering network 118 via one of four possible control flow paths. The online gaming network 116 is a network that is operated by an entity that allows users to play online games against other users, but does not itself directly provide for online wagering. In contrast, the online wagering network 118 is a network that provides for online gaming and also directly supports wagering on such gaming. FIG. 1C illustrates an exemplary interface that may be presented to a user to enable such a user wager or play for money during a match. In one embodiment, a user 102 may initiate access to a network by activating the gaming device and then inserting a game media 104 device into the gaming device 112. The game media 104 device can be a CD or DVD or other types of recordable media such as a cartridge that stores game software 114. The gaming device 112 runs game software 114 stored on game media 104. The user 102 can select the online gaming network 116 option via a built-in game software interface. An online gaming network interface is presented to the user when the user selects the online gaming network 116. The user 102 may choose to select the online wagering network 118 option via the built-in game software interface. An online wagering network interface is presented to the user when the user selects the online wagering network 118 option.

In another embodiment, the user 102 may select to connect to the online gaming network 116 through an online gaming network software 106. An online gaming network interface 120 is presented to the user when such a user 102 successful connects to the online gaming network 116. In another embodiment, the user 102 is presented with an online wagering network interface 122 when the user selects to connect the online wagering network 118 via wagering software 108 selected from the gaming device 112. In another embodiment, the user 102 may select to run a downloaded game software 110 that is stored on the gaming device 112. The user can select the online gaming network 116 option via a built-in game software interface. An online gaming network interface 120 is presented to the user when the user selects the online gaming network 116. The user 102 may choose to select the online wagering network 118 option via the built-in game software interface. The online wagering network interface 122 is presented to the user when the user selects the online wagering network 118 option.

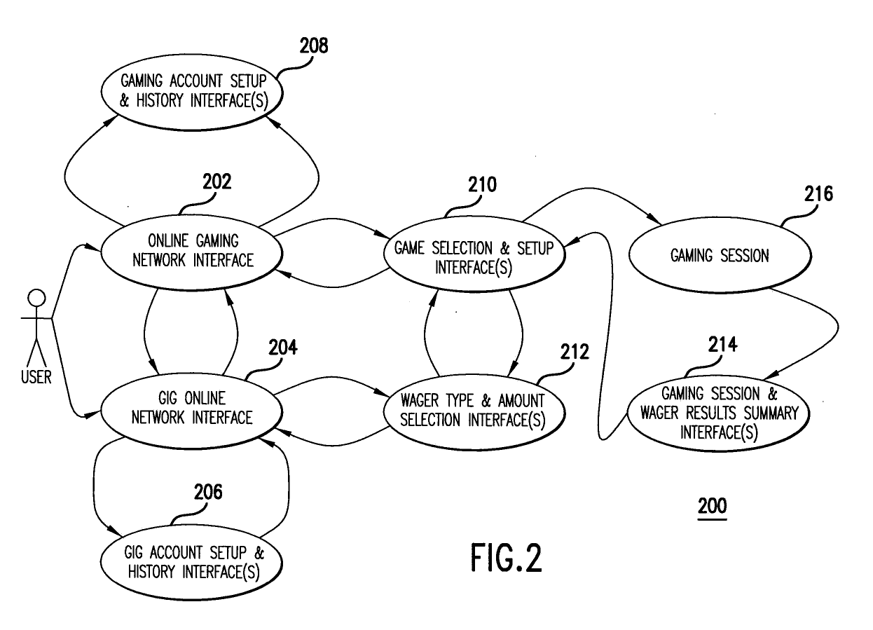

FIG. 2 illustrates, in flow-chart form, the process by which a user can select a game mode. In an embodiment, the user 102 can be presented with a gaming account setup & history interface 208 when the user 102 has connected to an online network via an online gaming network interface 202. The gaming account setup & history interface 208 enables a user 102 to submit his/her name, credit card or bank account identification, mailing address, telephone number, and/or any other user identifier in order to participate in tournaments or cash game challenges against other players. In another embodiment, the user 102 can be presented with a wagering account setup & history interface 206 when the user 102 has connected to an online wagering network via an online wagering gaming network interface 204. In such embodiments, the account is not specific to any particular game title or platform but rather can be used to access the host wagering network, using the same sign-on credentials, from any device or software/game title, and is linked to a single account for each user. The user 102 may be permitted to alternate between the online gaming network interface 202, and the online wagering gaming network interface 204. Such alternation between the online gaming network interface 202 and the online wagering gaming network interface 204 may occur when the user desires to verify a score or check the status of matches taking place in another interface. Of course, a user may alternate between the interfaces (202, 204) for other reasons. The wagering account setup & history interface 206 enables a user 102 to submit his/her name, credit card or bank account identification, mailing address, telephone number, and/or any other user identifier in order to participate in tournaments or cash game challenges against other players. As used herein, tournaments are games with a finite start and finite end where a specific number of players enter and once the match begins, no more players are allowed to enter. Cash games are games with no finite start or end. Users can enter or exit at any time. Cash games determine wins and losses based on each match and/or by a specific performance metric. As one example, a user can win money for winning a 10 minute match or the user can earn or lose a specified amount for each coin found or lost.

When the user 102 has successfully set up an account via account setup & history interface 208, the user 102 may proceed to return to the online gaming network interface 202. Next, the user 102 can be presented with an interface for selecting a tournament or cash game to enter. A user 102 that has previously created an account may bypass the account via account setup & history interface 208 and be directed to select a tournament or cash game through a game selection & setup interface 210. Further, a user 102 that has previously selected the online wagering network may be directed to select a wager type and amount to wager via a wager type & amount selection interface 212. The user 102 on the online wagering network can then be presented with the game selection & setup interface 210 in order that the user 102 may select and enter the tournament or cash game. The game selection & setup interface 210 presents a user 102 to be presented with an interface to select a challenge based on game title, game genre, tournament or cash game, game maps, game rules, other players, wagers allowed, running time, total prize, buy-in amount, geographic location, age and/or gender of users. The user 102 may be presented with an interface element which can be a list which orders the top 10 users based on total winnings. This list can be global or specific to game title, game genre, tournament or cash game, game maps, game rules, other players, wagers allowed, running time, total prize and/or buy-in amount. As one example, a user (“A”) is presented with an interface to invite another user (“B”) to participate in an invite-only tournament or cash game. User B may then be presented with an interface detailing the invitation to an invite-only tournament or cash game. User B can have the option to accept or decline. If user B accepts a challenge with user A, or with a combination of user A and additional players, the match can be setup, begin or continue with the addition of user B. If user B declines, user A may be presented with an interface that details user B's declination. A user can set an option to decline all offers. A user can also set an option that prevents the user from receiving offers to participate in a tournament, cash-game challenge, or an invite-only request.

The user 102 on an online gaming network can also be presented with a wager type & amount selection interface 212 which permits the user 102 to set up a type of wager, and the amount to wager in the selected tournament or cash game. The user's account may be marked with a hold or charged for the challenge fee. Under either network (i.e., online gaming network, or online wagering network), when the user 102 has completed selecting the type of wager, the amount to wager, and/or setup the desired selected game, the user 102 can then proceed and compete/play in the tournament in a gaming session 216. When the tournament ends, performance metrics from the game may be recorded and stored in a database or on a file system on the network servers, or on the user's gaming device 112. Such performance metrics can also be presented via a gaming session & wager results summary interface 214. The user 102 may be charged for the entrance fee if he/she loses a tournament. When a user 102 wins a tournament, his/her account can be credited with the total sum of the winnings of the tournament, or the servers may record the information and then later mail a check to the user 102 for the same amount. When a user 102 enters a cash game, his/her account may be credited or debited a predetermined amount for each win or loss. Such credited or debited amount may be determined either by the end of a match or by each increment or decrement of a game specific metric, such as coins collected or lost. The user 102 can be presented with an interface for setting automatic cash-out or quit points based on a length of play time, a specific time or based on the value of a metric of the game. The user 102 can also specify the game settings, wager type and wager amount of a challenge, and the system can then automatically generate a challenge with one or more users who chose the same settings.

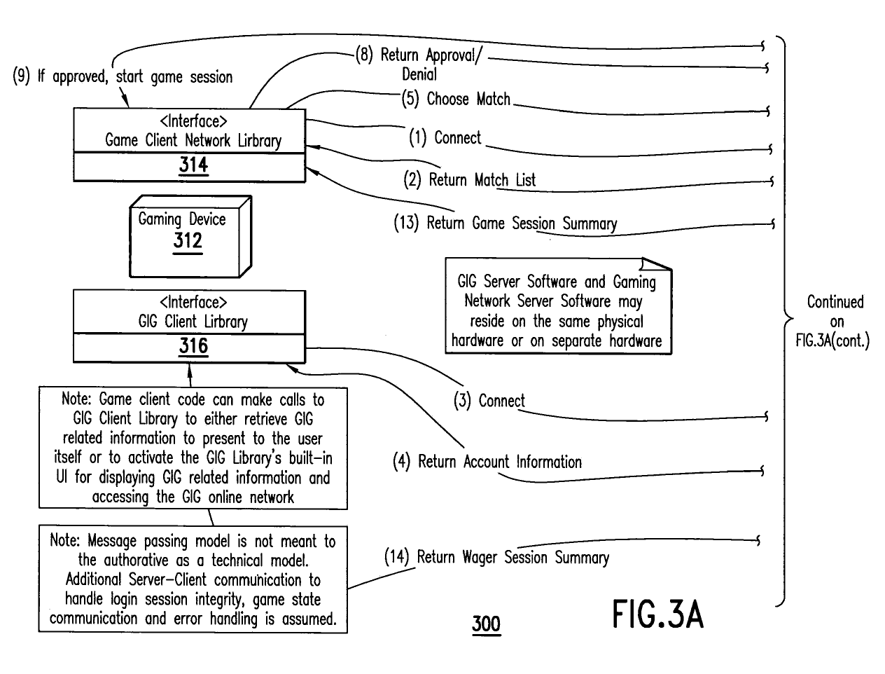

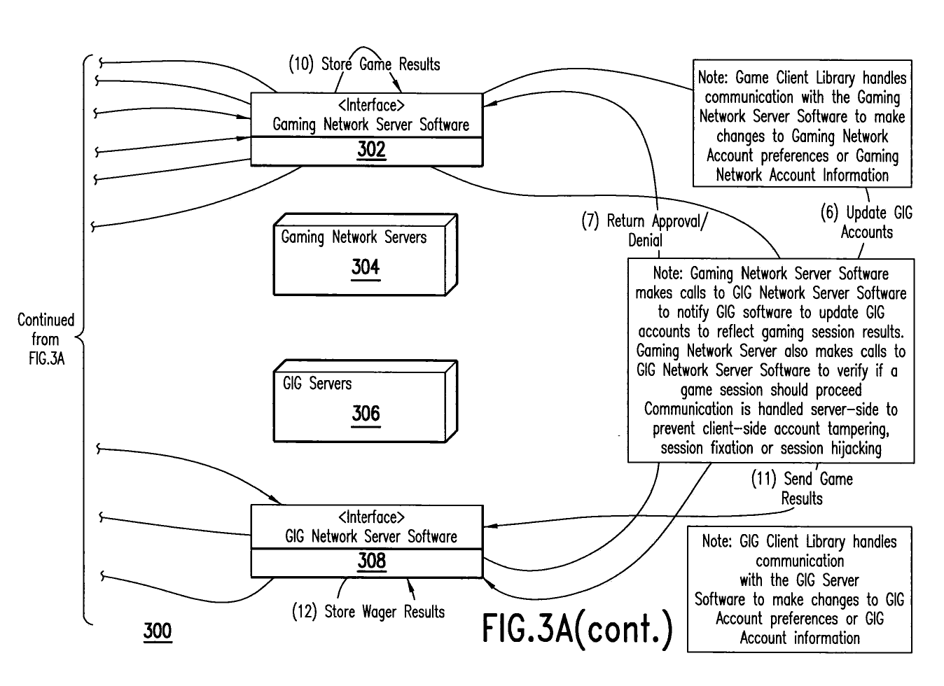

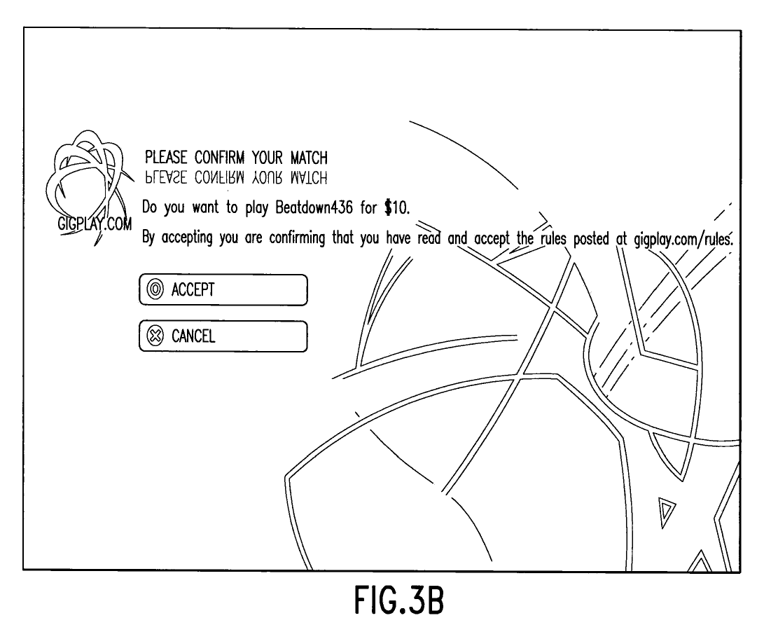

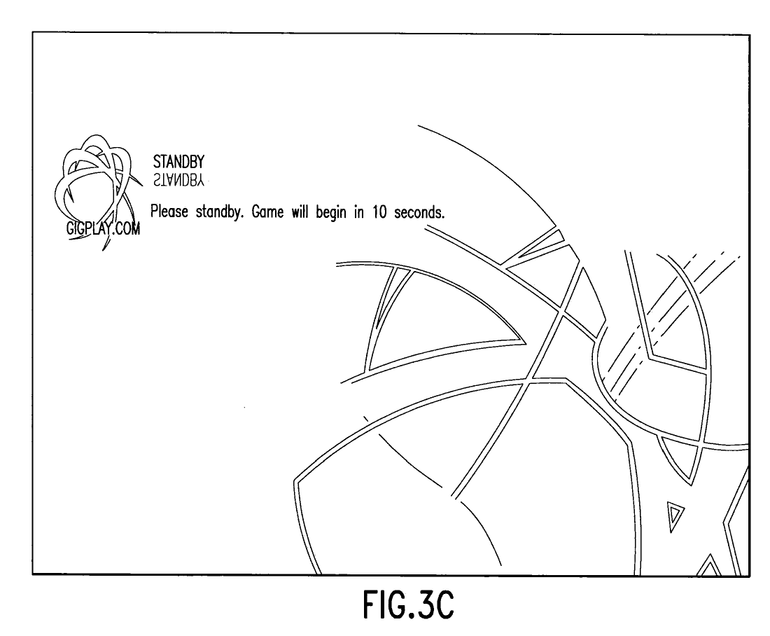

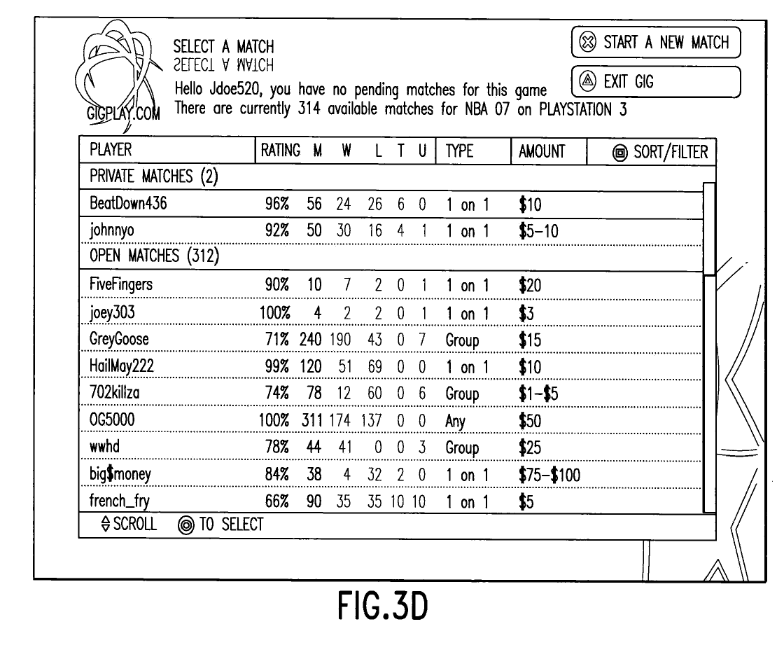

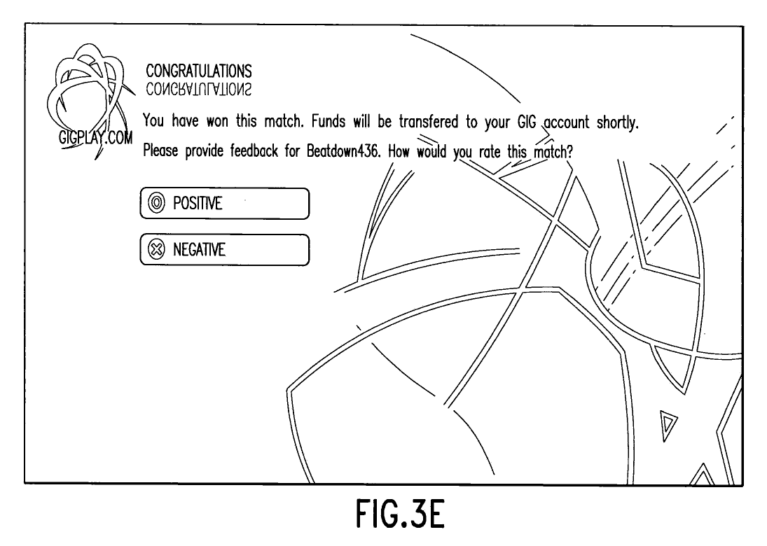

FIG. 3A illustrates a flow diagram of an exemplary transaction 300 for placing a wager according to one embodiment. The wagering can include a multi-player/single player live game using a gaming device 312. Players can be grouped into lobbies with a limited number of players in each lobby. When a player desires to initiate a match through the lobby he/she can submit a challenge including the amount he/she would like to wager (points or cash) and an optional message. The opponent can then be presented with the challenge which he/she can accept, reject or counteroffer. FIG. 3B illustrates an exemplary interface that can be presented to an opponent to accept or reject (cancel) an offer to play a match against another player. The “Accept” or “cancel” buttons can be activated by activated by the opponent. The opponent's acceptance, rejection, or counteroffer can also include the desired amount to wager and/or an optional comment. When one of the two players accepts an offer or counteroffer the match is initiated.

Thus, in operation 1, the process can begin with gaming device 312 connecting to gaming network server software 302. FIG. 3C illustrates an exemplary interface which may be presented to a user/player after he/she accepts an offer to play a match against an opponent. The gaming device 312 may include an interface that permits access to and from a game client network library 314. The game client network library 314 can be an interface configured to connect to a gaming network server 304 that includes gaming network server software 302. The game client network library 314 may handle communication with a gaming network server software 302 in order to make changes to gaming network account preferences and/or gaming network account information. Such network account preferences and/or gaming network account information may also be stored on a financial institution server.

In operation 2, the gaming network server software 302 may return a match list to the game client network library 314. The match list may be displayed via the game client network library interface 314, wherein the game client network library interface 314 may include a visual pane which lists users by name, nickname, handle, icon or other visual identification. Each of the players name may be linked to an associated visual element that reports a users winnings, challenges, user rank, odds in favor of player against the user, as well as information detailing current challenges scheduled or engaged in. The associate visual element can be a tool-tip popup that appears when the display cursor moves over the user name, a separate visual pane that is updated to reflect the current selection, and/or a new layout presented to the user when a challenger's name is highlighted and an action element is selected or a specific form of user input on the control device occurs. The game client network library interface 314 may also include a visual pane which can graphically separate and organize a user's performance based on game genre, game title, challengers, wins, losses, game times, specific game maps or game rules, odds against challengers, game lists organized the total, average, smallest or largest size of prize won. Specific games can be broken down into game specific performance metrics beyond wins and losses, such as collecting the most coins or rings in a match. Further, the game client network library interface 314 can include a visual pane containing a map, chart, graph or spreadsheet reflecting betting and game activity. A global visual overlay in the form of a ticker, transparent panel, in-game panel, symbolic or numeric feedback, tool-tip, toolbar, menu item, widget or scrolling information feed can also be included in the game client network library interface 314. Currency can also be presented in real or virtual form via the game client network library interface 314. As one example, real form may be represented by the number of dollars, while virtual form may be represented by peanuts. The gaming network server software 302 may also automatically generate a list of players for the user to challenge. Such generated list of players may be based on a player's performance history, which includes wins, losses and other game specific metrics. The generated list of players may also be based on length of time and amount of time the user and/or player has spent using the software or a particular game; the variation in choice of maps, skill of competitors, choice of game genre, title or specific game rules; the total winnings in points or dollars accumulated by the user and the potential players; the total winnings and performance history of challengers matched against the user or potential players; and/or other system, environment or software values which could be used to determine a list of challengers.

In operation 3, the wagering client library 316 can be configured to connect to a wagering server 306 that may include wagering network server software 308. The wagering server 306 may require some form of authentication from the wagering client library prior to granting permission to the wagering client library 316 to connect. Such authentication may require providing the wagering server 306 with a credential or code associated with the wagering server. The wagering client library 316 may handle communication with the wagering network server software 308 to update wagering account preferences and/or wagering account information which may be stored on the wagering server 306. The gaming device 312 can include an interface that permits access to and from a wagering client library 316.

In operation 4, the updated account information may be returned by the wagering server 306 and stored in the wagering client library 316. The wagering network server software 308 can be configured to make calls to the wagering client library 316 to retrieve wagering related information to present to the user, and/or to activate a wagering library interface. Wagering related information can be displayed on the wagering client library interface 316. The wagering client library interface 316 can also provide access to the online wagering network.

In operation 5, the game client network library interface 314 may provide the user with an option to choose a match to participate in after the wagering server 306 has returned the account information to the wagering client library 316. FIG. 3D illustrates an exemplary interface that may be presented to a prospective user so that such a user may choose a match to participate in. The interface can display the number of players that may be available to participate in a particular type of game. The interface can also display the win-loss record, ratings and/or rankings of each player. Such information can serve to inform a player of the type of opponent the player may decide to compete against. This information may also be pertinent when deciding an amount to wager in a tournament or match.

In operation 6, the gaming network server 304 can be configured to communicate with the wagering server 306 by means of their respective software 302, 308 in order to notify the wagering network server software 308 to update wagering accounts to reflect the match chosen by the user. The gaming network server 304 can also be configured to update the wagering accounts of the gaming session results of the user. The game client network library 314 may handle communication with a gaming network server software 302 to update and/or make changes to gaming network account preferences and/or gaming network account information. Such network account preferences and/or gaming network account information may also be stored on a financial institution server 310.

In operation 7, the wagering network server software 308 may return or notify the gaming network server software 302 of whether the financial institution 310 approved or denied holds associated with the user. The gaming network server software 302 can also return such approval or denial information associated with the user to the game client network library 314, in operation 8. Communication can occur between the gaming network server 304 and the wagering server 306 to verify if a game session may proceed. Such communication between the gaining network server 304 and the wagering server 306 can be configured to be handled on the server-side in order to prevent client-side account tampering, session fixation or session hijacking. If approved, the user may be permitted to start a game session, in operation 9.

In operation 10, the gaming network server software 302 may store the game results associated with the game session on the financial institution servers 310. Further, the gaming network server software 302 can be configured to organize tournaments or cash games based on the total prize amount, the amount wagered per user, the skill of users involved, the game title, game map, game rules, metrics allowed to wager on, or in the case of a cash game, metrics of the game including length of time played, largest winnings and largest losses. Such information can also be stored on the financial institution server 310. The gaming network server software 302 may also be configured to manage reconnections to a cash or tournament game after a user is disconnected, and/or an application crash occurs due to an unintentional or external system failure (client, server or network). The gaming network server software 302 configuration can specify time limits to allow a user to rejoin a gaming session, limit the number of rejoins, and/or provide an option to allow another user that may be picked by the original user who is selected from a queue or randomly selected to take the place of a disconnected user.

In operation 11, the gaming network server software 302 may be configured to send game results of the game session to the wagering network server software 308. In operation 12, the wagering network server software 308 can cause the wager results to be stored on the wagering server 306. The wagering network server software 308 can be in communication with financial institutions to deduct/siphon automatic winnings of users based on a percentage or a raw number to a virtual account, bank account or back into a tournament or cash game. As one example, a user may win $100. The wagering network server software 308 can then automatically store 30% in an account and re-bet 70% for the next match. The game wagering system and method can be configured with a feedback system, wherein some games may be integrated with a wagering exchange system. Thus, the wagering network server can independently verify the outcome of the game and may settle the wager accordingly. If the players do not come to a consensus, the match can be considered undecided resulting in the money wagered to be refunded minus the wagering network's transaction fee. Players are encouraged to leave feedback for one another at the conclusion of a match. FIG. 3E illustrates an exemplary interface that can be presented to a player so that the player can provide either “positive” or “negative” feedback about his/her opponent. Such feedback can be public information and may be used by others to evaluate the integrity of a player in the future. Feedback may comprise a positive or negative rating and/or an optional comment regarding the match. If a player receives negative feedback he/she may be given the opportunity to publish a response comment. Such a player may be able to officially contest the feedback through a wagering network administrator.

In operation 13, the gaming network server software 302 can return a game session summary to the game client network library interface 314 when the transactions by the financial institution servers 310 are completed. In operation 14, the wagering server 306 can be configured to provide a wager session summary to the wagering client library 316. This may be facilitated by the wagering network server software which can enable the game client code to communicate with the wagering client library 316 to retrieve wagering network related information to present to the user. The game client code can also activate the wagering library interface to display wagering network related information and/or to access the online wagering network.

Although the present invention has been described in connection with the illustrated embodiments, it will be appreciated and understood that modifications may be made without departing from the spirit and scope of the invention.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A system for facilitating wagering by a user on a game of skill, comprising:
a gaming network server;
a user gaming device, the user gaming device including a display device, an input device, and a communications device, the communications device being operable to communicate with the gaming network server, the user gaming device being configured to allow the user to participate in a game of skill against at least one opponent; and
a wagering server;
wherein the wagering server is configured to have the capability to accept a wager from the user gaming device or from the gaming network server.

2. The system of claim 1, wherein the user gaming device requests the placing of a wager by communicating with the gaming network server, and the gaming network server sends a message to the wagering server indicating the request from the user gaming device.

3. The system of claim 2, wherein the user gaming device is configured to request the placing of the wager through commands included on a physical gaming media read by the user gaming device.

4. The system of claim 2, wherein the user gaming device is configured to request the placing of the wager through commands downloaded to the user gaming device from the gaming network server.

5. The system of claim 1, wherein the user gaming device requests the placing of a wager by communicating with the wagering server.

6. The system of claim 5, wherein the user gaming device is configured to request the placing of the wager through commands included on a physical gaming media read by the user gaming device.

7. The system of claim 5, wherein the user gaming device is configured to request the placing of a wager through commands downloaded to the user gaming device from the wagering server.

8. The system of claim 5, wherein the wagering server is configured to transmit a list of matches available for wagering to the user gaming device for display thereon.

9. The system of claim 1, wherein the wagering server is configured to accept a wager on an aspect of the game other than overall win or loss.

10. The system of claim 1, wherein the wagering server is configured to accept an indication of a result of the game on which the wager is based from the gaming server.

11. The system of claim 1, wherein the wagering server is configured to accept an indication of a result of the game on which the wager is based from the user gaming device.

12. The system of claim 1, wherein the wagering server is further configured to accept an indication of a result of the game on which the wager is based from the at least one opponent, and wherein the wage is settled if the user and the at least one opponent reach consensus on the result.

13. The system of claim 1, wherein the wagering server is configured to maintain an account for the user, and wherein the account may be accessed by the user regardless of whether a wager is placed from the user gaming device or from the gaming network server.

14. A method for facilitating wagering on a game of skill, comprising:
accepting on a wagering server a first wager from a user gaming device, the user gaming device configured to allow the user to participate in a game of skill against at least one opponent; and
accepting on the wagering server a second wager from a gaming network server, the gaming network server being configured to host a game of skill.

15. The method of claim 14, further comprising:
configuring the user gaming device to request the placing of the first wager at the wagering server through commands included on a physical gaming media read by the user gaming device.

16. The method of claim 14, further comprising:
configuring the user gaming device to request the placing of the wager through commands downloaded to the user gaming device from the wagering server.

17. The method of claim 14, further comprising:
configuring the user gaming device to request from the gaming network server the placing of the second wager through commands included on a physical gaming media read by the user gaming device.

18. The method of claim 14, further comprising:
configuring the user gaming device to request from the gaming network server the placing of the second wager through commands downloaded to the user gaming device from the gaming network server.

19. The method of claim 14, further comprising:
transmitting a list of matches available for wagering to the user gaming device for display thereon.

20. The method of claim 14, wherein the first or second wager is on an aspect of the game other than overall win or loss.

21. The method of claim 14, further comprising:
receiving at the wagering server an indication of a result of the game on which the second wager is based from the gaming server.

22. The method of claim 14, further comprising:
receiving at the wagering server to accept an indication of a result of the game on which the first wager is based from the user gaming device;
receiving at the wagering server an indication of a result of the game on which the wager is based from at least one opponent; and
settling the wager if the user and the at least one opponent reach consensus on the result.

23. The method of claim 14, further comprising:
maintaining at the wagering server an account for the user, wherein the account may be accessed by the user regardless of whether a wager is placed from the user gaming device or from the gaming network server.
